(19) United States
(12) Patent Application Publication
(10) Pub. No.: US 2006/0198779 A1
(43) Pub. Date: Sep. 7, 2006

(54) Selective non-catalytic reduction of NOx

(76) Inventors: Boyd E. Hurst, Louisville, KY (US); William J. McLaughlin, Houston, TX (US); David G. Knight, Houston, TX (US); Theresa J. Hochhalter, Annandale, VA (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(21) Appl. No.: 11/353,488

(22) Filed: Feb. 13, 2006

Related U.S. Application Data
(63) Continuation-in-part of application No. 10/427,265, filed on May 1, 2003, now abandoned.
(60) Provisional application No. 60/386,560, filed on Jun. 5, 2002.
(60) Provisional application No. 60/386,492, filed on Jun. 5, 2002.
(60) Provisional application No. 60/442,268, filed on Jan. 24, 2003.

(51) Int. Cl. B01D 53/56

(52) U.S. Cl. 423/239.1

(57) ABSTRACT

A non-catalytic process for NOₓ concentrations in process streams wherein a reducing agent and a readily-oxidizable gas are injected into a NOₓ-containing process stream to reduce the concentration of the NOₓ-containing process stream while minimizing the carryover of the unreacted reducing agent.

### CROSS-REFERENCE TO RELATED APPLICATIONS

This application is a continuation-in-part of U.S. patent application Ser. No. 10/427,265 filed May 1, 2003, which claims benefit of the following U.S. Provisional Patent Applications: Ser. No. 60/386,560 filed Jun. 5, 2002; Ser. No. 60/386,492 filed Jun. 5, 2002; and Ser. No. 60/442,268 filed Jan. 24, 2003.

### FIELD OF THE INVENTION

The present invention relates to a non-catalytic process for reducing NOₓ concentrations in process streams. More particularly, the present invention relates to the injection of a reducing agent in combination with a readily-oxidizable gas to reduce NOₓ emissions in process stream effluents.

### BACKGROUND OF THE INVENTION

Increasingly stringent government regulatory emission standards have forced refiners to explore, and in some cases to implement, improved technologies for reducing the concentration of nitrogen oxides (NOₓ) in emissions from combustion and production effluent streams. For example, it is known in the art to reduce NOₓ concentrations in combustion effluent streams by the injection of ammonia, and one such patent covering this technology is U.S. Pat. No. 3,900,554 to Lyon, which is incorporated herein by reference. After this Lyon patent, there was a proliferation of patents and publications relating to the injection of ammonia into combustion effluent streams in order to reduce the concentration of NOₓ. Such patents include U.S. Pat. Nos. 4,507,269, Dean et al., and 4,115,515, Tenner et al., both of which are also incorporated herein by reference. Other patents disclose the use of ammonia injection based on the use of kinetic modeling to determine the amount of ammonia to be injected. Such patents include U.S. Pat. Nos. 4,636,370, 4,624,840, and 4,682,468, all to Dean et al., and all of which are also incorporated herein by reference. There have also been a number of patents and publications relating to the injection of urea into combustion effluent streams in order to reduce the concentration of NOₓ. One such patent covering this technology is U.S. Pat. No. 4,208,386 to Arand et al., which is incorporated herein by reference. A study by Kim and Lee (1996), incorporated herein by reference, published in the Journal of Chemical Engineering of Japan shows that urea dissociates to ammonia and cyanuric acid (HNCO) and that both of these act as reducing agents for NO in two interrelated chains of free radical reactions.

However, effluents released from process streams remain a source of NOₓ. Particularly troublesome NOₓ pollutants found in many process effluent streams are NO and NO₂. The NOₓ emissions rates for industrial processes are regulated in the United States by the Environmental Protection Agency (“EPA”) and other local environmental agencies. NO₂ is a major component of smog and NO is readily converted to NO₂ when exposed to sunlight in the presence of O₂. Some of the major industrial processes contain large amounts of NO in the process streams.

Examples of such process streams that are a source of NOₓ include the off-gas stream from the regenerator of a fluidized catalytic cracking unit, (“FCCU”) and a carbon monoxide combustion/heat recovery unit (COHRU) used in conjunction with a FCCU. In particular, the FCCU process typically generates significant amounts of NOₓ wherein most of the NOₓ, often in the range of 90% of the total NOₓ, is in the form of NO. This NO in the process stream is particularly difficult to remove without first converting the NO to elemental nitrogen or higher nitrogen oxide species. NOₓ in an FCC off-gas effluent results from the burning of carbon deposits from the spent catalyst. However, it is difficult to burn the carbon deposits from a spent catalyst without generating NOₓ in the off-gas. NOₓ produced in the regenerator and present in the off-gas is typically passed to the COHRU, which converts CO in the FCCU regenerator off-gas to CO₂ and other products such as water and/or steam. As the COHRU converts CO to CO₂ and other products, the effluent emitted into the atmosphere also contains NOₓ. It is difficult to reduce the NOₓ concentrations in these streams by thermal means, partially because of the low temperatures of these process streams. Some catalyst fines may also be present in the regenerator off-gas. The effect of catalyst fines on NOₓ reduction was demonstrated at temperatures below 850° F. in U.S. Pat. No. 4,434,147, Dimpfl et al., incorporated herein by reference. The '147 patent describes a process in which ammonia and FCCU regenerator off-gas are cooled, then passed through a bed of FCCU catalyst fines created by collecting the fines on specially adapted electrostatic precipitator plates.

Hydrogen (H₂) injection has been utilized in the past to enable the non-catalytic, ammonia-based, NOₓ reduction process to be more effective with lower temperature combustion effluent streams. While hydrogen injection has been used before with ammonia to reduce NOx in low temperature combustion streams, the amount of NOₓ released to the atmosphere is still too high for more stringent environmental regulations. Therefore, there exists a need in the art for improved methods of reducing the emission of NOₓ in refinery process streams by non-catalytic means. Current NOₓ emission limits depend on site regulations, but are commonly in the range of 50 ppm for an average FCC unit. Due to the relatively large volume of NOₓ emitted per year by such NOx producers as an FCC unit, even small decreases in the parts per million levels of NOₓ emitted from these units amounts to tons of pollutant emissions that can be eliminated in a single year from such a unit. Many of these units are operating at the limits of current cost effective technology for these high-volume NOₓ generating units. Therefore, improvements even as small as a 5-10 vppm reduction in NOₓ emissions on a commercial FCC unit are significant in light of the current art.

Another problem that exists in the art is that non-catalytic, ammonia (NH₃) based NOx reduction processes, such as disclosed U.S. Pat. No. 3,900,554 to Lyon, can result in significant amounts of ammonia in the treated gas stream. This can result in excessive ammonia emissions and in certain applications, as in an FCCU, a significant portion of the unreacted ammonia converts into ammonium salts which can be corrosive and which tend to deposit on related downstream equipment, such as heat exchange equipment, turbines, scrubber slurry lines, environmental analyzer sample systems, etc. These corrosive and restrictive salt deposits can cause significant equipment deterioration and system failures. Additionally, in an FCCU, much of the ammonia left in the treated streams is removed via FCCU waste or recycle streams to the refinery's waste water system for treatment. These sophisticated modern water treatment systems normally include treatment plant bioreactors which are an essential component of the waste water treatment processes required to meet strict EPA water quality guidelines. Here, in these bioreactors, the ammonia can kill the biological matter upon which the modern waste water treatment plant relies on to break down the organic pollutants to meet these mandated clean water discharge permit limitations.

In addition, if excess NH₃ is utilized in these processes (resulting in “ammonia slip”), the NH₃ reaching downstream combustion equipment will oxidize to NOₓ, decreasing the net NOₓ reduction achievable via these processes. Therefore, in processes where there is combustion equipment downstream of an ammonia (NH₃) based NOₓ reduction process, it is particularly important that the ammonia slip be controlled to low levels. A problem with the processes existing in the art is being able to simultaneously achieve both high levels of NO reduction and low levels of downstream unreacted ammonia concentrations.

Therefore, there exists in the art the need for an economic, non-catalytic process with improved NOₓ emissions reduction capabilities. In addition, there exists a need in the art for an effective NOₓ removal process with low levels of unreacted ammonia which is detrimental to air quality emissions, water quality emissions, and associated equipment reliability, longevity, and functionality.

### SUMMARY OF THE INVENTION

In one embodiment, the present invention provides a non-catalytic process for reducing the NOₓ concentration in the regenerator off-gas of a fluid catalytic cracking unit, comprising:
a) forming a mixture of a reducing agent selected from ammonia, urea and mixtures thereof, and a first readily-oxidizable gas in effective amounts that will result in the reduction of the NOₓ concentration of the regenerator off-gas by a predetermined amount;
b) injecting said mixture into said regenerator off-gas at a first injection point wherein the regenerator off-gas is at a temperature between about 1200° F. and 1600° F.; and
c) injecting a second readily-oxidizable gas at a second injection point downstream of the first injection point in an amount effective to further reduce the amount of NOₓ concentration of the regenerator off-gas and to reduce the concentration of the reducing agent in the regenerator off-gas.

In another embodiment, the reducing agent is injected in a molar ratio of about 1 to about 10 moles per mole of NO.

In still another embodiment, the mixture injected into the first injection point is comprised of the first readily-oxidizable gas and the reducing agent in a molar ratio of about 1 to about 20 moles of readily-oxidizable gas per mole of reducing agent.

In still another embodiment, the second readily-oxidizable gas is injected in a molar ratio of about 1 to about 40 moles of second readily-oxidizable gas per mole of unreacted reducing agent from said first injection point.

In a preferred embodiment, the final NOₓ concentration of said regenerator off-gas at a point downstream of said second injection point is less than 50 vppm.

In still another preferred embodiment, the reduction of the NOₓ concentration of said regenerator off-gas is greater than 50 vol %.

In a more preferred embodiment, the reducing agent is ammonia and the concentration of the ammonia by vol % of the regenerator off-gas after the second injection point is at least 60% lower than the concentration of the ammonia by vol % of the regenerator off-gas between the first injection point and the second injection point.

### BRIEF DESCRIPTION OF THE FIGURES

FIG. 1 shows a highly simplified schematic of a commercial FCCU regenerator off-gas circuit similar to the circuit from which the test data included herein was obtained.

FIG. 2 shows a plot of the NOₓ concentration in the FCCU regenerator off-gas stream as a function of the NH₃/NO ratio of the first injection point at varying H₂/NH₃ ratios. The NOₓ baseline readings for the regenerator off-gas stream without H₂/NH₃ injections are also shown on the plot for similar timeframes. This data was obtained from injection of hydrogen and ammonia at a single injection point into the regenerator off-gas stream of a commercial fluidized catalytic cracking unit.

FIG. 3 shows a plot of the NOₓ concentration in the FCCU regenerator off-gas stream as a function of the NH₃/NO ratio of the first and second injection points at varying H₂/NH₃ ratios. The NOₓ baseline readings for the regenerator off-gas stream without H₂/NH₃ chemical injections are also shown. This data was obtained from the injection of hydrogen and ammonia at a first injection point into the regenerator off-gas stream of a commercial fluidized catalytic cracking unit followed by the injection of hydrogen at a second injection point into the regenerator off-gas stream.

FIG. 4 shows a plot of the same data as shown in FIG. 3, wherein the data was averaged and reformatted to more clearly illustrate the effects on NOₓ as a function of NH₃/NO ratio for varying first and second injection point H₂/NH₃ ratios.

FIG. 5 shows a plot of the NH₃ concentration in the FCCU regenerator off-gas stream as a function of the NH₃/NO ratio for varying first and second injection points at varying H₂/NH₃ ratios. The NH₃ baseline readings for the regenerator off-gas stream without H₂/NH₃ chemical injections are also shown. This data was obtained from the injection of hydrogen and ammonia at a first injection point into the regenerator off-gas stream of a commercial fluidized catalytic cracking unit followed by the injection of hydrogen at a second injection point into the regenerator off-gas stream.

### DETAILED DESCRIPTION OF THE PRESENT INVENTION

As used herein, the reference to NOₓ, or nitrogen oxide(s) refers to the various oxides of nitrogen that may be present in process streams such as, for example, the off-gas of the regenerator of a fluidized catalytic cracking unit. Thus, the terms refer to all of the various oxides of nitrogen including nitric oxide (NO), nitrogen dioxide (NO₂), nitrous oxide (N₂O), etc. and mixtures thereof.

Mixing, as used herein when describing the mixing of the reducing agent and readily-oxidizable gas, is meant to refer to the broadest meaning given the term. Thus, mixing refers to the objective of maximizing the local contact of the reducing agent and readily-oxidizable gas with the NOₓ in the process stream at the desired molar ratios. Any suitable mixing techniques can be employed to achieve this end. These techniques include, but are not limited to, using a carrier gas with the reducing agent and/or readily-oxidizable gas to encourage more homogenous mixing; injecting a premixed stream of a reducing agent, readily-oxidizable gas and carrier gas into the process stream; or, injecting a stream of reducing agent and carrier gas and a stream of readily-oxidizable gas and carrier gas into the process stream separately.

Non-limiting examples of suitable pre-injection mixing techniques, processes or means include piping the reducing agent, readily-oxidizable gas and carrier gas through separate lines into one common vessel or into the injection line to the process stream to be treated, allowing the two reagents and the carrier to mix as they flow towards the injection point.

An embodiment is a non-catalytic process that uses an effective amount of a reducing agent injected with an effective amount of a readily-oxidizable gas to reduce the NOₓ concentration of a process stream preferably by a predetermined amount or to below a specified concentration limitation. By a predetermined amount it is meant a reduction of NOₓ by more than about 30% by volume, and preferably more than about 50% by volume, based on the total volume of NOₓ present in the process stream. By the term a specified concentration limitation, the final NOx concentration limitation or target should be expressed in vppm (parts per million by volume) of NOₓ. For an FCC regenerator off-gas stream, this limitation is preferably 50 vppm, more preferably 40 vppm, and even more preferably 30 vppm. In a most preferred embodiment, the predetermined reduction of NOₓ or NOₓ limitation is at least that amount sufficient to meet governmental regulatory emission standards.

The present process is suitable for treating any process stream containing NOₓ and greater than about 0.1 vol. % oxygen, based on the volume of the stream. Preferably the stream will contain about 0.4 to about 1.5 vol. % oxygen, although embodiments including about 0.1 to about 3.0 vol. % oxygen are contemplated to be within the scope of the process described herein. The present process is especially well-suited for treating the regenerator off-gas of a fluidized catalytic cracking unit.

Fluidized catalytic cracking is an important and widely used refinery process. The catalytic cracking process typically converts heavy oils into lighter products such as gasoline. In the fluidized catalytic cracking (FCC) process, an inventory of particulate catalyst is continuously cycled between a cracking reactor and a catalyst regenerator. Average reactor temperatures are in the range of about 900-1000° F., with average feed temperatures from about 500-800° F. The reactor and the regenerator together provide the primary components of the catalytic cracking unit. FCC process units are well known in the art and U.S. Pat. No. 5,846,403, Swan, et al., incorporated herein by reference, provides a more detailed discussion of such a unit.

The regenerator is especially important to catalyst life and effectiveness because during the fluidized catalytic cracking process, carbonaceous deposits (coke) are formed on the catalyst, which substantially decrease its activity. The catalyst is then typically regenerated to regain its effectiveness by burning off at least a portion of the coke in the regenerator. This is typically done by injecting air, or another gas having a combustible amount of oxygen, into the regenerator at a rate sufficient to fluidize the spent catalyst particles. A portion of the coke contained on the catalyst particles is combusted in the regenerator, resulting in regenerated catalyst particles. Typical regenerator temperatures range from about 1200° F. to about 1600° F.

After regeneration, the catalyst particles are cycled back to the reactor. The regenerator off-gas is usually passed to further processes such as heat recovery devices, particulate removal devices, and carbon monoxide combustion/heat recovery units (COHRU), which, as previously mentioned, are designed to convert CO to CO₂ and recover available fuel energy. However, the specific equipment and/or equipment configuration associated with an FCCU regenerator off-gas system may vary in design from installation to installation.

However, regardless of the equipment configuration, it is difficult to burn a substantial amount of coke from the catalyst in the regenerator without increasing the NOₓ content of the resulting off-gas. Therefore, the regenerator off-gas will typically contain nitrogen oxides (NOₓ), catalyst fines, sulfur oxides (SOₓ), carbon dioxide, carbon monoxide, and other compounds formed during the combustion of at least a portion of the coke from the catalyst particles. Of the nitrogen oxides present in the regenerator off-gas, nitric oxide (NO) typically makes up the majority of all NOₓ present. NO will usually represent about 90% of the total NOₓ in the regenerator off-gas. Therefore, the presently claimed process is especially concerned with the reduction and control of NO.

It may be preferred to operate the regenerator in full burn mode to burn coke from the catalyst. During full-burn mode, the regenerator off-gas composition is generally about 0.6-1.5 vol. % oxygen, about 15-20 vol. % water, about 50 to about 200 parts per million by volume (vppm) NO, about 20-50 vppm CO, about 500-1000 vppm SO₂ with the balance being N₂ and CO₂.

Concentrations of NOₓ in process streams can be reduced by 50 vol. % or more through the use of the present non-catalytic NOₓ reduction process. This is well within the desired reduction range described above. The only commercially available technology to achieve such a level of reduction is technology based on the use of a catalytic process, which is significantly more expensive when compared to the present non-catalytic process.

The present invention, however, achieves NOₓ reductions in low temperature process streams by the injection of a reducing agent. The process streams treated with the presently claimed process also typically have low concentrations of oxygen, necessitating the use of a readily-oxidizable gas being injected with the reducing agent.

Reducing agents suitable for use in the presently claimed invention include urea, ammonia, and mixtures thereof. The preferred reducing agent is ammonia. Readily-oxidizable gases suited for use in the present process include paraffinic, olefinic and aromatic hydrocarbons and mixtures thereof such as, for example, gasoline and fuel oil, oxygenated hydrocarbons including formic and oxalic acids, nitrogenated hydrocarbons, sulfonated hydrocarbons, carbon monoxide, and hydrogen. Hydrogen is the preferred readily-oxidizable gas since it is not itself an air pollutant and cannot yield an air pollutant by incomplete oxidation.

By injection, it is meant that the readily-oxidizable gas, the reducing agent, or combinations thereof are conducted or introduced into the NOₓ containing process stream to be treated. This injection may be performed by any suitable means known in the art. The injection means chosen is not critical to the present invention as long as it is one that effectively introduces the reducing agent and/or readily-oxidizable gas into the process stream for adequate contact and mixing.

An effective amount of reducing agent used herein is based on the amount of NOₓ that is to be reduced. The amount of reducing agent used will typically range from about 1 to 10 moles of reducing agent per mole of NOₓ, preferably about 3 to 8 moles of reducing agent per mole of NOₓ. The measurement of the concentration of NOₓ in the regenerator off-gases may be achieved by any suitable method known in the art, and the method chosen is not critical to the process presently claimed.

It is believed that a complex chain of free radical reactions achieves the non-catalytic reduction of NOₓ with the present reducing agent and readily-oxidizable gas. Not wanting to be limited by theory, the inventors herein believe the overall effect can be illustrated by the following two competing reactions:
NO+NH₃+O₂→N₂+H₂O (reduction) Equation 1
NH₃+O₂→NO+H₂) (oxidation) Equation 2

The use of urea as the reducing agent introduces cyanuric acid (HNCO) as well as ammonia to the process. As demonstrated in the work of Lee and Kim (1996), cyanuric acid acts as a reducing agent for NO and also interacts with the NO—NH₃—O₂ chemistry summarized in Equations 1 and 2. Although the cyanuric acid reduction process is not thoroughly understood, and not wishing to be limited by theory, the inventors hereof believe that the dissociation of one mole of urea liberates one mole of ammonia and one mole of cyanuric acid. Experimental data from the Kim and Lee study (1996) suggests that cyanuric acid stoichiometrically reduces NO to elemental nitrogen and water at a molar ratio with NO of 1:1. Thus, urea should generally be used at a molar ratio to NO that is roughly one half the effective molar ratio for ammonia.

The reduction reaction of Equation 1 dominates in the 1600° F.-2000° F. temperature range. Above 2000° F., the reaction of Equation 2 becomes more prevalent. Thus, in the practice of the present invention, it is desirable to operate at temperatures below about 2000° F. However, operating temperatures lower than about 1600° F. are achievable with the reduction reaction still being dominated by Equation 1 through the use of the present invention. It has been found herein that, at temperatures below about 1600° F., the reduction reaction of Equation 1 will not effectively reduce NOₓ without the injection of a readily-oxidizable gas, such as hydrogen. However, it has also been found that a single injection point containing the reducing agent and the readily-oxidizable gas cannot achieve the significantly improved NOₓ reduction that may be achieved by utilizing a second injection point. In order to achieve significant NOₓ reduction improvements over a single injection point, it has been discovered that a readily-oxidizable gas must be injected at a second injection point downstream of the first injection point in very specific ratios.

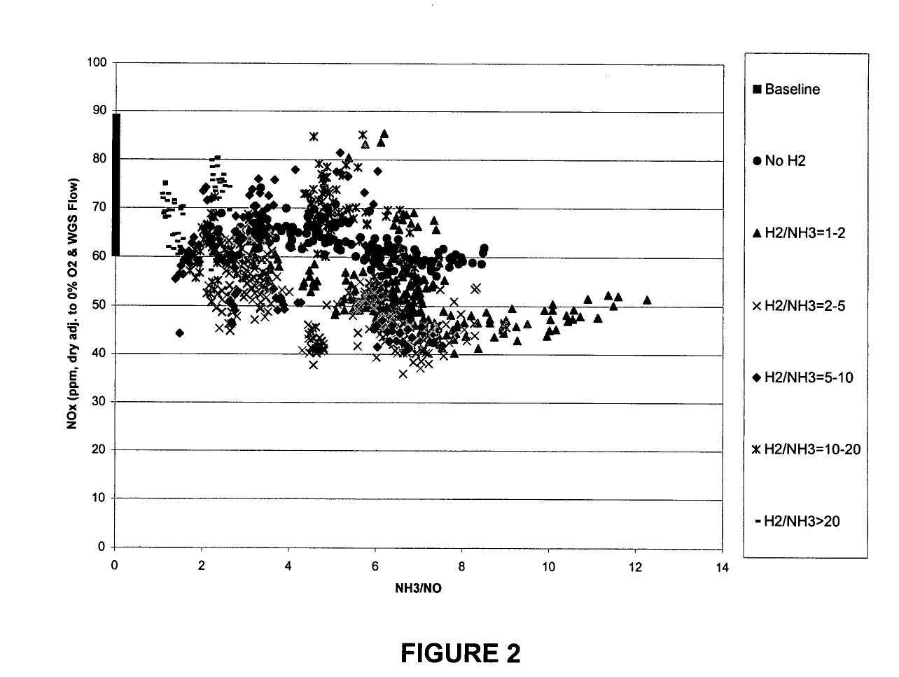

Additionally, it has been found that in order to maximize the reduction of NOₓ that the NH₃/NOₓ ratio needs to be above about 3. However, it has been found that these limitations are very narrow and that there are no improvements of NOₓ reduction above NH₃/NOₓ ratios of about 8. However, applicants have found that at NH₃/NOₓ ratios above about 2, significant amounts of NH₃ remain in the process stream. As stated before, this can cause significant environmental and equipment problems. It has been unexpectedly discovered that by injecting a high volume of readily-oxidizable gas at a second injection point downstream of the first injection point, that the ammonia content in the final process stream can be significantly reduced. As are shown in Examples 1-2 and FIGS. 2-5, by introducing a second stream of a readily-oxidizable gas in specific ratios, significant reductions in NOₓ and NH₃ emissions can be achieved over the prior art.

It should be noted that as the temperature of the process stream decreases, the amount of readily-oxidizable gas needed to drive the reduction reaction increases. However, it has been determined herein that by injecting specific molar ratios of a reducing agent and a readily-oxidizable gas at a first injection point coupled with a secondary injection of a readily-oxidizable gas further downstream as disclosed herein can be used at an effective operating temperature range below about 1600° F. This makes the present embodiment especially suited for reducing NOₓ concentrations in the off-gas of an FCCU regenerator because the temperature of the regenerator off-gas stream is typically low, below about 1600° F. It should be noted, however, that the present embodiments can also effectively operate over any temperature range between about 1200° F. to about 1600° F.

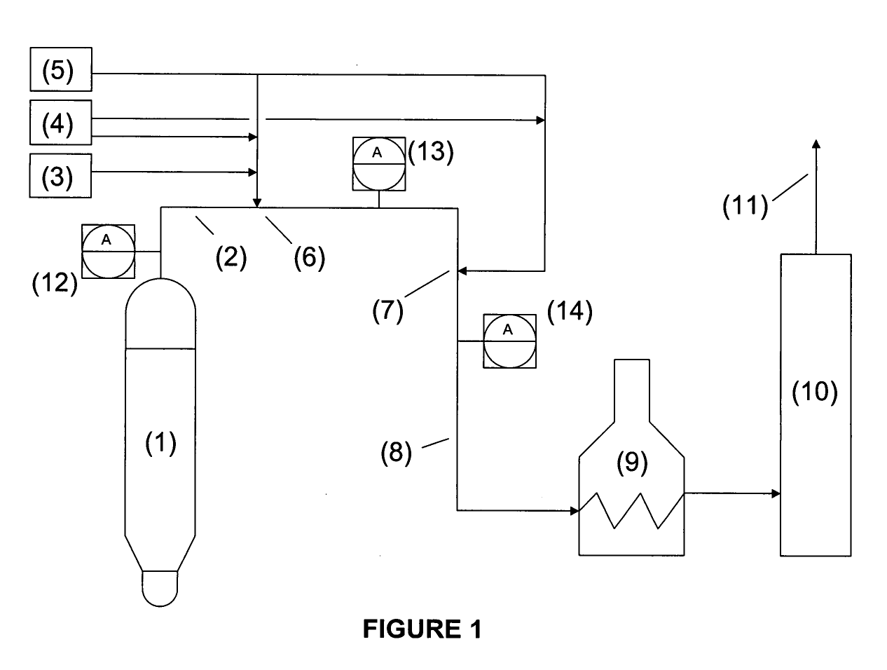

FIG. 1 shows a highly simplified schematic of an FCC unit regenerator off-gas configuration. This sketch eliminates many of the extraneous circuits and equipment associated with the operation of such a complex unit. This figure shows a carbon monoxide combustion/heat recovery unit (COHRU) downstream of the regenerator followed by a wet gas scrubber system. Most FCC units also have additional catalyst particulate removal units in this circuit. Other FCC units may not have a COHRU, but instead have a waste heat recovery boiler and may also utilize a gas expander for energy recovery. However, the present embodiments apply to all such configurations. But, as this illustrates, most FCC units contain significant expensive machinery, including catalyst disengaging equipment, rotating equipment, heat exchangers, emissions treating equipment, and analyzer and controls equipment that can be damaged by the corrosive agents (such as NOₓ and ammonia salts) that the FCCU process and the NOₓ reduction processes of the prior art can generate.

Returning to FIG. 1, the FCC unit regenerator (1), produces a regenerator off-gas (2) in the range of about 1200 to about 1600° F. This gas contains a significant amount of steam and carbon dioxide, oxygen, and unwanted contaminants such as carbon monoxide, nitrous oxides, sulfur oxides, and ammonia. In the present invention, a reducing agent (3) and a readily-oxidizable gas (4) are injected at a first injection point (6) into the regenerator off-gas. Optionally, a carrier gas (5), such as steam or air, may be utilized to help increase the velocity of the injection stream and improved mixing and dispersion of the stream within the regenerator off-gas stream. The readily-oxidizable gas (4) is also injected at a second injection point (7) downstream of the first injection point. While it is not known exactly how far downstream the second injection point must be located with respect to the first injection point, the second injection point should be far enough downstream to prior allow the reaction of reducing agent and the readily-oxidizable gas from the first injection point with the regenerator off-gas to reach near equilibrium.

Continuing with FIG. 1, the treated regenerator off-gas (8) proceeds through a carbon monoxide combustion/heat recovery unit (COHRU) (9) wherein the carbon monoxide (CO) is thermally reacted to convert the majority of the CO to carbon dioxide (CO₂). The off-gas stream is then routed to a was gas scrubber (WGS) (10) where the regenerator off-gas undergoes an additional liquid scrubbing treatment, normally for the removal of particulates and SOₓ, where after the treated off-gas is discharged to the atmosphere (11). On-line analyzers may be may optionally be placed at following locations to measure certain stream composition characteristics for analysis: at the regenerator outlet (12), between the first injection point and the second injection point (13), and downstream of the second injection point (14). These on-line analyzers can be for data collection only or can be used to provide feedback to varying controls systems to either automatically control the injection rates and/or compositions of the injection streams of the present invention, or to control other aspects of the FCCU process. These analyzers may detect concentrations such as, but not limited to, NOₓ, SOₓ, ammonia, hydrogen, carbon monoxide, and carbon dioxide. As part of this invention, it should be noted that it is not necessary to have any or all of the on-line analyzers so listed, although information obtained from such analyzers can be beneficial in optimizing the control of the injection systems of the present process. It should also be noted that additional analyzers may be located at other points in the FCC unit regenerator off-gas circuit depending upon which molecular compounds are to be measured or which aspects of the process are being controlled as a result of the stream analysis.

The data presented in FIGS. 2 through 5 were obtained through tests on a commercial FCCU regenerator off-gas stream similar to as shown in the simplified depiction of FIG. 1. The data included in these figures and the associated analyses are further detailed in Examples 1 and 2.

A readily-oxidizable gas is used to induce the NOₓ reduction reaction. An effective amount of readily-oxidizable gas is that amount that enables the reducing agents of the present invention to effectively reduce the NOₓ concentration by a determined amount. A molar ratio of about 1 to about 20 moles of a first readily-oxidizable gas per mole of reducing agent is considered an effective amount of first readily-oxidizable gas. Preferably this molar ratio is 1 to about 8, more preferably about 1 to about 3. The actual molar ratio employed will be dependent on such things as the temperature of the process stream; the composition of the process stream; the effectiveness of the injection means used for mixing the readily-oxidizable gas with the carrier gas, the reducing agent and the NOₓ-carrying stream; and the reducing agent utilized. Thus, for a given process stream, the most effective readily-oxidizable gas to reducing agent molar ratio may lie anywhere within a range of about 1 to about 20 moles of a first readily-oxidizable gas per mole of reducing agent range.

A readily-oxidizable gas is required for the reduction reaction of NO and the reducing agent at lower temperatures (typically below about 1600° F.) and at process low oxygen levels (typically below 3.0 vol. % oxygen). Most typical refinery process streams, including the FCC unit regenerator off-gas, have low oxygen levels, thus necessitating the need for the use of readily-oxidizable gas in combination with the reducing agent and the process stream in order to achieve a considerable NOₓ reduction. In addition, low temperatures in the process stream (<1600° F.) also contribute to the need for a readily-oxidizable gas. However, it has been discovered that there are limitations that may be achievable by a single injection of a readily-oxidizable gas and a reducing agent in achieving adequate NOₓ reduction in these process streams.

It has also been discovered that there is a limitation to the amount of reducing agent that can properly react with the NO in the process gas regardless of the amount necessary to reduce the NO to elemental nitrogen. This can be seen in FIG. 2, wherein overall NOₓ reduction with a single injection point does not improve with NH₃/NO ratios greater than about 8. Also referring to FIG. 2, final average NOₓ concentrations below 40 to 60 vppm could not be achieved regardless of the H₂/NH₃ ratio employed.

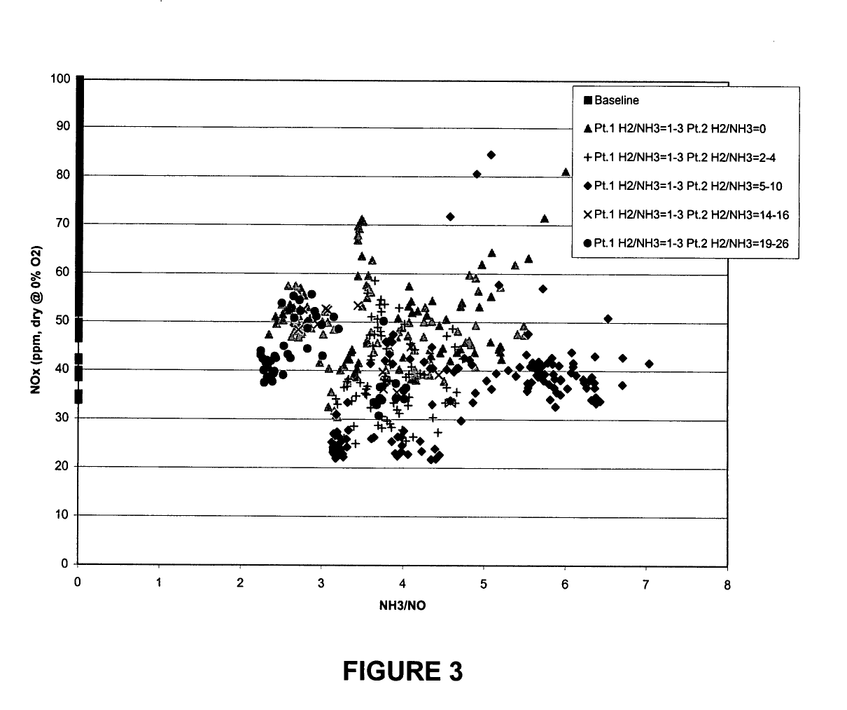

It has been unexpectedly discovered that by additionally introducing a readily-oxidizable gas at a second point at an effective distance downstream of the first injection point that NOₓ levels can be reduced to levels on the order of 25% to 50% lower than achievable by the use of a readily-oxidizable gas and a reducing agent in a single injection point. These results can be seen in FIG. 3, where final average NOₓ levels of 20 to 40 vppm were achieved by the present invention. It should be noted here that these levels of NOₓ reduction are extremely significant when put in context of the relatively large levels of NOₓ emitted by an average FCC unit and the need in the industry to continually decrease these emissions. Excessive emissions are not only harmful to the environment, but can result is large environmental fines for non-compliance, significantly more costly processes than the present invention to meet regulation limits, and/or the possibility of shutting down such units and the associated loss of revenues to meet non-compliance orders.

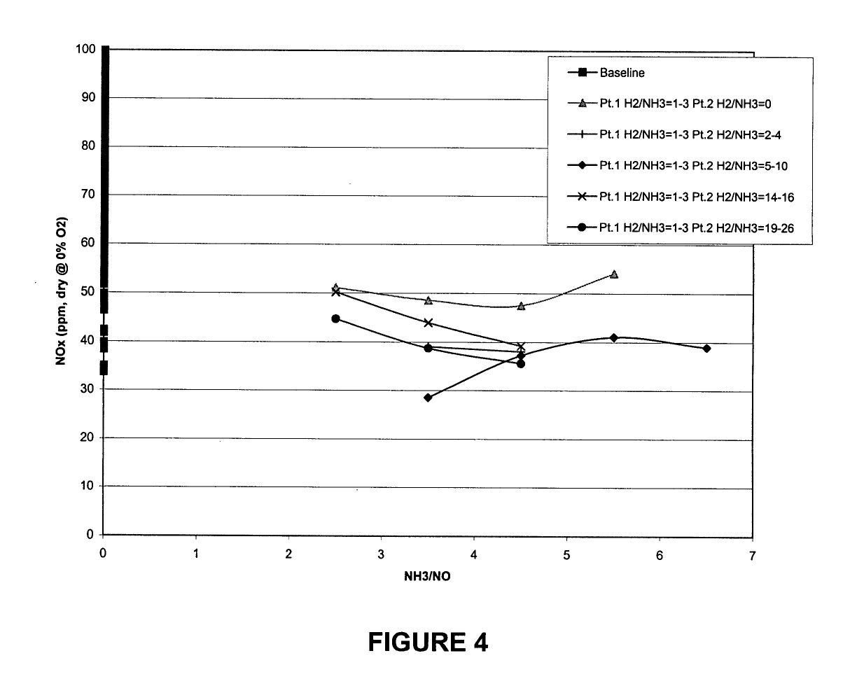

FIG. 4 shows the same data a plot of the same data as shown in FIG. 3, wherein the data was averaged and reformatted to more clearly illustrate the effects on NOₓ as a function of NH₃/NO ratio for varying first and second injection point H₂/NH₃ ratios. As can be seen in FIG. 4, the higher H₂/NH₃ ratios at the second injection point unexpectedly showed a trend of lower NOₓ levels than the lower H₂/NH₃ ratios at the second injection point. It can also be seen in the scatter data of FIG. 3, that the higher levels of H₂/NH₃ ratios at the second injection point resulted in more consistent NOₓ removal levels as compared to those achieved by the lower levels of H₂/NH₃ ratios shown in the same figure.

It should be noted that the readily-oxidizable gas utilized in FIGS. 2 through 5 was hydrogen and that when reviewing FIGS. 3 through 5, that only hydrogen (with a steam carrier) was injected at second injection point. Therefore, the “Pt. 2 H2/NH3” ratios shown in FIGS. 3 through 5 is the ratio of the measured hydrogen injected at the second injection point to the calculated unreacted ammonia remaining at the second injection point.

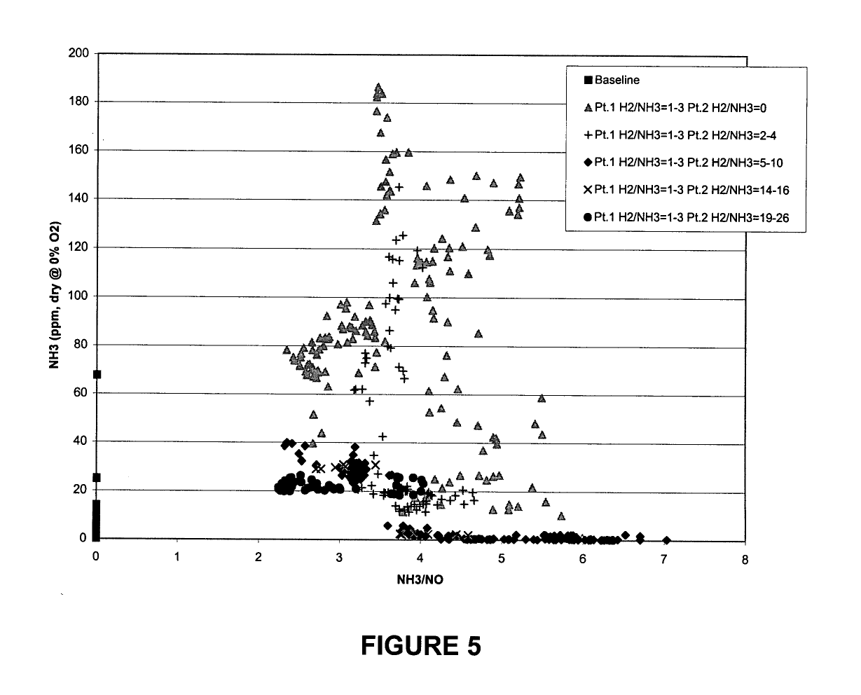

In addition to the significant improvement in NOₓ reductions discussed, it has been discovered that significant amounts of unreacted ammonia remain in the process stream even at relatively low NH₃/NO ratios (see FIG. 5 where the triangles mark the points of no secondary hydrogen injection) and that addition of a secondary readily-oxidizable gas injection can significantly reduce the unreacted ammonia in the process stream. In FIG. 5, it can be seen, that with no secondary gas injection, that the ammonia levels fluctuate severely from an average of about 80 vppm to absolute readings as high as 180 vppm. Introduction of a readily-oxidizable gas at a secondary injection point reduces the ammonia levels to below 40 vppm and eliminates the high fluctuation of ammonia levels in the regenerator off-gas stream. As noted prior, these high ammonia levels can result in emissions problems as well as significant equipment reliability and functionality problems, and waste water treatment facility upsets and failures.

Since the amount of readily-oxidizable gas and reducing agent used are typically a small percentage of the regenerator off-gas flow, typically less than about 0.5% by volume, based on the volume of the stream, it is preferred to use only an effective amount of a readily available and relatively inexpensive carrier material. Non-limiting examples of carrier materials include air and steam; however, any carrier material that does not have a deleterious effect on NOₓ reduction, or which itself contributes to undesirable emissions, can be used. Thus, it is contemplated to mix effective amounts of reducing agent and/or readily-oxidizable gas prior to mixing with a carrier material, or within the line that contains the carrier material. It is preferred that the reducing agent/readily-oxidizable gas mixture be injected into the line that conducts the carrier material.

By an effective amount of carrier material, it is meant an amount of carrier material that will adequately mix the reducing agent and/or the readily-oxidizable gas with the process stream, i.e., maximize the contact of the reagents with the NOₓ sought to be reduced.

As previously stated, the regenerator off-gas also typically contains catalyst fines. These catalyst particles may be removed from the regenerator off-gas by any suitable means known in the art. However, the presence of catalyst fines in the regenerator off-gas is believed to assist the NOₓ reduction reaction. Thus, the presence of some catalyst fines, although not necessary for the practice of the instant invention, is preferred to assist the NOₓ reduction reaction and reduce the amount of readily oxidizable gas that is needed.

In one embodiment of the present invention, effective amounts of a reducing agent and a first readily-oxidizable gas, preferably with an effective amount of carrier material, are injected directly into the regenerator's existing overhead line. Thus, the existing overhead line functions as the reaction zone for the NOₓ reduction reaction, thereby eliminating the need to add costly processing equipment to effectuate the present process. It is preferred that both the first and the second injection points be located in the regenerator off-gas line prior to any associated downstream processing equipment. A most preferred configuration is that the injection points be located as near the regenerator off-gas outlet as possible so that the higher temperatures near the regenerator outlet can be utilized, thereby reducing the amount of readily-oxidizable gas needed for a desired level of NOₓ reduction. It is also advantageous to maximize the residence time of the reducing agent and readily-oxidizable gas in the NOₓ reduction reaction.

In another embodiment, at least two or more injection points of a reducing agent and a readily-oxidizable gas may be utilized prior to the final injection point wherein only the readily-oxidizable gas is injected, preferably with a carrier gas, to achieve the low stream NOₓ concentrations of the present invention. In this embodiment, the multiple injection points are preferably spaced such that the appropriate residence time between locations is achieved such that the desired effect from the use of multiple injection locations is realized. As previously mentioned, it is advantageous to maximize the residence time of the reducing agent and readily-oxidizable gas in the overhead line to complete the reactions.

In still another embodiment, it may be advantageous to have at least one or more injection points of a reducing agent and a readily-oxidizable gas followed by one or more injection points wherein only the readily-oxidizable gas is injected, preferably with a carrier gas, to achieve the low stream NOₓ. In this embodiment, it would be more preferred if the readily-oxidizable gas was injected with the reducing agent at a relatively low readily-oxidizable gas to reducing agent ratio, followed by more than one successive injections of a readily-oxidizable gas with successively higher readily-oxidizable gas to reducing agent ratios.

The above description is directed to several preferred means for carrying out the present invention. Those skilled in the art will recognize that other means and modifications, which are equally effective and obvious to those skilled in the art, could be devised for carrying out the spirit of this invention.

### EXAMPLES

The present NOₓ reducing process was tested at a commercial FCCU under normal operating conditions. The configuration of the two injection points and major equipment was as shown in FIG. 1 with the exception that an intermediate analyzer (shown in FIG. 1 as element (18)) was not installed. Therefore, the remaining unreacted NH₃ after the first injection point was not measured directly, but was based on calculations from “ammonia slip” data compiled when operating the regenerator off-gas NOₓ treatment configuration without the second injection point.

The following examples will illustrate the effectiveness of the present process, but are not meant to limit the present invention.

### Example 1

In this example, the NOₓ reduction configuration for the FCCU regenerator off-gas was tested with only a single injection point injecting different ratios of a reducing agent (in this case NH₃) and a readily-oxidizable gas (in this case H₂). This first point injection point is shown in FIG. 1 as point (6). In this example, the second injection point (7) was not utilized.

Data from the testing is shown in FIG. 2. Here it can be seen that the NOₓ baseline readings for the regenerator off-gas ranged from approximately 60 to 90 ppm NOₓ (see data plotted on y-axis). The data plot in FIG. 2 illustrates the NOₓ concentration as a function of the NH₃/NO ratio at differing H₂/NH₃ injection ratios. It can be seen from this graph, most importantly, that the lowest consistent NOₓ levels achievable are from about 40 to 60 ppm. Here it can also be seen that only at NH₃/NO levels from about 3 to about 8 can these NOₓ levels of about 40 to 60 ppm be achieved.

It can also be seen in FIG. 5 that while operating at the NH₃/NO ratio levels from about 3 to about 8 which are necessary to achieve maximum NOₓ reduction, it has been found that the ammonia levels in the regenerator off-gas stream can be extremely high. This is shown by the “triangle” data points where the secondary injection point is 0 (i.e., “Pt.2 H2/NH3=0”). These data points show that within this NH₃/NO range, the ammonia levels average about 80 vppm with individual readings as high as 180 vppm. It can also be seen that in this NH₃/NO range, that the ammonia levels fluctuate severely and therefore are not readily predictable or controlled.

### Example 2

In this embodiment of the present invention, the NOₓ reduction configuration for the FCCU regenerator off-gas was tested with a two-injection point system. A molar ratio of a reducing agent (in this case NH₃) to a readily-oxidizable gas (in this case H₂) of 1 to 3 was injected at the first injection point. At the second injection point, only the readily-oxidizable gas (in this case H₂) was injected. The data from these tests can be shown in FIGS. 3, 4, and 5. In these figures, the “Pt.2 H2/NH3” ratios shown in the legends are the ratio of the measured hydrogen injected at the second injection point to the calculated unreacted ammonia remaining at the second injection point.

FIG. 3 shows the NOₓ in the treated regenerator off-gas stream as a function of the NH₃/NO molar ratio at various injection point H₂/NH₃ molar ratios. FIG. 4 shows the same data as FIG. 3, except the results were averaged and plotted at different NH₃/NO ratios. The data from FIG. 4 shows that the higher H₂/NH₃ molar ratios at the second injection point (i.e., the curves showing “Pt.2 H2/NH3” molar ratios of 14-16 and 19-26) trend to lower NOₓ concentrations as the NH₃/NO increases. It can also be seen in FIG. 3, that the lower H₂/NH₃ molar ratios at the second injection point (i.e., the curves showing “Pt.2 H2/NH3” molar ratios of 0, 2-4 and 5-10) are less consistent in the regenerator NOₓ readings than the higher H₂/NH₃ molar ratios at the second injection point.

It can be seen from FIG. 3, that the NOₓ in an FCCU regenerator off-gas is reduced to less than 50 vppm (parts per million by volume), preferably less than 40 vppm, more preferably less than 30 vppm. It can also be seen from FIG. 4 that the average NOₓ level without injection is approximately 75 vppm and that NOₓ levels of 30 to 40 vppm may be achieved with this embodiment of the present invention. This results in an overall NOₓ reduction of 45 to 60 vol %.

FIG. 5 shows the NH₃ concentrations of the regenerator off-gas stream as a function of the NH₃/NO molar ratio. As can be seen, the higher H₂/NH₃ molar ratios at the second injection point (i.e., the curves showing “Pt.2 H2/NH3” molar ratios of 5-10, 14-16 and 19-26) improve the reduction in ammonia in the regenerator off-gas that results from the first injection point. Therefore, this embodiment of the present invention results in improved NOₓ reduction and lower ammonia concentrations (i.e., “slip”) in the regenerator off-gas of an FCCU.

It can be seen from FIG. 5, that without secondary injection of a readily-oxidizable gas (e.g. hydrogen), that that average NH₃ levels are about 80 to 100 vppm. In comparison, this embodiment of the present invention results in NH₃ levels less than 30 vppm. This is a reduction of about 60% to about 70% in NH₃ levels than if a secondary injection of a readily-oxidizable gas is not utilized in conjunction with the first injection of a reducing agent and a readily-oxidizable gas into the FCCU regenerator off-gas.

1. A non-catalytic process for reducing the NOₓ concentration in the regenerator off-gas of a fluid catalytic cracking unit, comprising:
a) forming a mixture of a reducing agent selected from ammonia, urea and mixtures thereof, and a first readily-oxidizable gas in effective amounts that will result in the reduction of the NOₓ concentration of the regenerator off-gas by a predetermined amount;
b) injecting said mixture into said regenerator off-gas at a first injection point wherein the regenerator off-gas is at a temperature between about 1200° F. and 1600° F.; and
c) injecting an additional amount of a second readily-oxidizable gas at a second injection point downstream of the first injection point in an amount effective to further reduce the amount of NOₓ concentration of the regenerator off-gas and to reduce the concentration of the reducing agent in the regenerator off-gas.

2. The process of claim 1, wherein said readily-oxidizable gas is selected from the group consisting of paraffinic, olefinic and aromatic hydrocarbons and mixtures thereof, gasoline, fuel oil, oxygenated hydrocarbons, formic and oxalic acids, nitrogenated hydrocarbons, sulfonated hydrocarbons, carbon monoxide, and hydrogen.

3. The process according to claim 2, wherein said first readily-oxidizable gas and said second readily-oxidizable gas are hydrogen.

4. The process according to claim 3, wherein said reducing agent is injected in a molar ratio of about 1 to about 10 moles per mole of NO.

5. The process according to claim 4, wherein said reducing agent is injected in a molar ratio of about 3 to about 8 moles per mole of NO.

6. The process according to claim 5, wherein said mixture comprises said first readily-oxidizable gas and said reducing agent in a molar ratio of about 1 to about 20 moles of readily-oxidizable gas per mole of reducing agent.

7. The process according to claim 6, wherein said mixture comprises said first readily-oxidizable gas and said reducing agent in a molar ratio of about 1 to about 8 moles of readily-oxidizable gas per mole of reducing agent.

8. The process according to claim 7, wherein said mixture comprises said first readily-oxidizable gas and said reducing agent in a molar ratio of about 1 to about 3 moles of readily-oxidizable gas per mole of reducing agent.

9. The process of claim 8, wherein the reducing agent is ammonia.

10. The process of claim 7, wherein said second readily-oxidizable gas is injected in a molar ratio of about 1 to about 40 moles of second readily-oxidizable gas per mole of unreacted reducing agent from said first injection point.

11. The process of claim 10, wherein said second readily-oxidizable gas is injected in a molar ratio of about 3 to about 26 moles of second readily-oxidizable gas per mole of unreacted reducing agent from said first injection point.

12. The process of claim 11, wherein said second readily-oxidizable gas is injected in a molar ratio of about 14 to about 26 moles of second readily-oxidizable gas per mole of unreacted reducing agent from said first injection point.

13. The process of claim 9, wherein said second readily-oxidizable gas is injected in a molar ratio of about 3 to about 26 moles of second readily-oxidizable gas per mole of unreacted reducing agent from said first injection point.

14. The process of claim 1, wherein the final NOₓ concentration of said regenerator off-gas at a point downstream of said second injection point is less than 50 vppm.

15. The process of claim 14, wherein the final NOₓ concentration of said regenerator off-gas at a point downstream of said second injection point is less than 40 vppm.

16. The process of claim 11, wherein the final NOₓ concentration of said regenerator off-gas at a point downstream of said second injection point is less than 30 vppm.

17. The process of claim 12, wherein the final Nₓ concentration of said regenerator off-gas at a point downstream of said second injection point is less than 30 vppm.

18. The process of claim 11, wherein the said reduction of the NOₓ concentration of said regenerator off-gas is greater than 50 vol %.

19. The process of claim 12, wherein the said reduction of the NOₓ concentration of said regenerator off-gas is greater than 50 vol %.

20. The process of claim 11, wherein said reducing agent is ammonia and the concentration of the ammonia by vol % of said regenerator off-gas after said second injection point is at least 60% lower than the concentration of the ammonia by vol % of said regenerator off-gas between said first injection point and said second injection point.

21. The process of claim 12, wherein said reducing agent is ammonia and the concentration of the ammonia by vol % of said regenerator off-gas after said second injection point is at least 60% lower than the concentration of the ammonia by vol % of said regenerator off-gas between said first injection point and said second injection point.

22. The process of claim 20, wherein the concentration of ammonia of said regenerator off-gas after said second injection point is less than 40 vppm.

23. The process of claim 21, wherein the concentration of ammonia of said regenerator off-gas after said second injection point is less than 40 vppm.

24. The process according to claim 23, wherein said reducing agent and said first readily-oxidizable gas are injected with a carrier material selected from steam and air.

25. The process according to claim 24, wherein catalyst fines from the regenerator vessel of an FCC unit are present in the regenerator off-gas.

26. The process according to claim 11, wherein said second readily-oxidizable gas is injected into said regenerator off-gas at a plurality of injection points downstream of said first injection point wherein each injection point is located at a point further downstream than the prior injection point.

27. The process according to claim 12, wherein said second readily-oxidizable gas is injected into said regenerator off-gas at a plurality of injection points downstream of said first injection point wherein each injection point is located at a point further downstream than the prior injection point.

28. The process according to claim 26, wherein said second readily-oxidizable gas injected at each of the plurality of injection points is injected at a higher molar ratio of second readily-oxidizable gas to unreacted reducing agent than the immediately prior upstream injection point.

29. The process according to claim 27, wherein said second readily-oxidizable gas injected at each of the plurality of injection points is injected at a higher molar ratio of second readily-oxidizable gas to unreacted reducing agent than the immediately prior upstream injection point.
